(19) United States
(12) Patent Application Publication
(10) Pub. No.: US 2001/0016913 A1
(43) Pub. Date: Aug. 23, 2001

(54) Method of securing communication between two software elements via a non-secure communication channel

(76) Inventors: Bertrand Marquet, Antony (FR); Jean-Stephane Martin, Mennecy (FR); Guy Fouquet, Nozay (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/749,378

(22) Filed: Dec. 28, 2000

(30) Foreign Application Priority Data
Dec. 30, 1999 (FR) 99 16 720

(51) Int. Cl. H04L 9/00

(52) U.S. Cl. 713/201

(57) ABSTRACT

In a method of securing communication between a first software element and a second software element via a non-secure communication channel in collaboration with a security server, data carried by the communication channel is sent using a method of a security object supplied by the security server.

### BACKGROUND OF THE INVENTION

1. Field of the invention

The present invention relates to a method of securing communication between two software elements.

The two software elements can be installed on the same data processing system or on two different data processing systems. In the latter case, they communicate via a network. The network can be a computer network, which can be a local area network (LAN) or a wide area network (WAN), and in particular the Internet. The network can also be a telecommunication network, for example a radiocommunication network.

Thus the invention is independent of the nature of the network supporting the communication channel.

2. Description of the prior art

Securing communication between two elements, in particular software elements, via a communication channel is known in the art. For example, there are protocols based on first negotiating encryption keys and/or authentication tokens, for example the Needham and Schroeder protocol and its implementation in the “Kerberos” and “Sesame” servers. The Needham and Schroeder protocol is described in RFC (Request for Comments) 1004 of the IETF (Internet Engineering Task Force) entitled “A Distributed-Protocol Authentication Scheme”, for example.

The prior art protocols referred to above use a number of exchanges between the applications to negotiate the keys and/or tokens.

Accordingly, these solutions are insufficient in that they have a major weakness in their initialization phase. They necessitate exchanges of messages before the secured communication is set up. These exchanges are therefore a major weakness of the prior art.

The object of the present invention is therefore to overcome this weakness by proposing a method of securing communication between two software elements via a non-secure communication channel which is free of weaknesses during the initiation phase.

### SUMMARY OF THE INVENTION

To this end, the invention provides a method of securing communication between a first software element and a second software element via a non-secure communication channel in collaboration with a security server, in which method data carried by the communication channel is sent using a method of a security object supplied by the security server.

The terms “methods” and “objects” must be understood in the sense that they are usually defined in the field of object-oriented programming. Thus a class of objects is a structure including both attributes, i.e. data, and methods, i.e. functions for manipulating the data. As a general rule, the attributes are not accessible by the other objects: the other objects can access the attributes only by means of a set of methods which form the interface between the object and the outside world, as it were.

The invention also provides a software element for implementing the above method, which software element includes:

a communication module for sending data via the communication channel in secured manner, and

means for receiving a new communication module from the security server.

The method according to the invention therefore solves the problem of the lack of security of the prior art solutions since it is no longer necessary to negotiate keys or tokens as in the solutions previously described.

What is more, because the security mechanism (or algorithm) is the responsibility of a security object that is not known to the software element, the latter no longer needs to be revealed to the software element developer.

In practice, only a programming interface needs to be known (i.e. one or more methods of the object, with its or their parameters), whereas the implementation is not known. Accordingly, the security algorithms themselves can be known only to the system itself (i.e. the security server), which makes hacking the security system much more difficult.

Clearly, as a general rule, the less information a hacker has on the security mechanism to be hacked, the more difficult hacking becomes.

Another advantage is the flexibility of the method according to the invention. Because the security mechanisms are implemented in security objects which are developed and managed independently of the software elements, they can be modified easily, without calling into question the software elements themselves.

Consequently, a change of security policy can be effected by a system administrator in a manner that is transparent for the software elements.

The change can even be effected dynamically, as and when required. In other words, it is not necessary to shut down the system to modify the security mechanism used. The modification consists in changing the security objects and the modification is naturally applied to the securing of communications when the new security objects are transmitted to the software elements necessitating them.

This possibility can be used to enhance further the security of the system from time to time by changing the security objects that can be transmitted from the security server and, in so doing, the underlying security mechanisms. The change can be effected periodically or at random, which further increases security.

The invention and its advantages are explained in the following description, which refers to the accompanying drawings.

### BRIEF DESCRIPTION OF THE DRAWINGS

FIG. 1 shows one embodiment of a system according to the invention.

FIG. 2 shows another embodiment of the invention using two security servers.

### DETAILED DESCRIPTION OF THE PREFERRED EMBODIMENTS

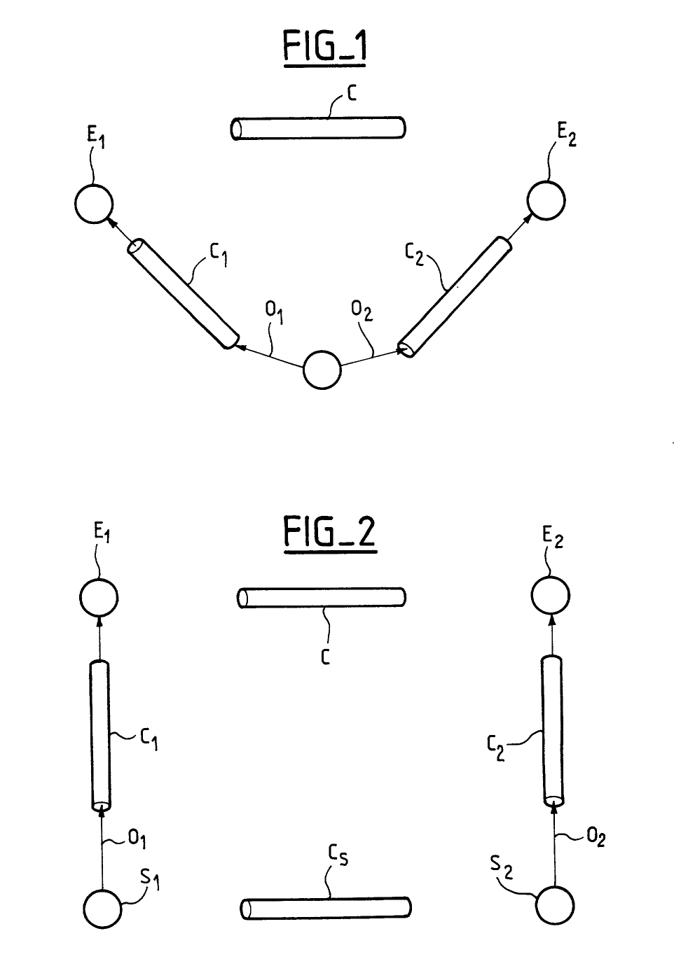

FIG. 1 shows two software elements E₁ and E₂ and a security server S. The software elements E₁ and E₂ use a non-secure communication channel C to communicate with each other, which means that third party software elements can read the data in transit on the communication channel.

The software elements first contact the security server(s) S which respond(s) by sending them security objects O₁ and O₂.

In a first embodiment there is a single central security server S for the entire system.

In another embodiment, shown in FIG. 2, the system includes a number of distributed security servers S₁, S₂. Thus a first server S₁ can send the security object(s) O₁ to the software element E₁ and a second server S₂ can send the security object(s) O₂ to the software element E₂.

In an embodiment of this kind the security servers must be able to communicate with each other via a communication channel C_{S} in order to implement a common security policy, or at the very least certain common elements of different security policies. To be more precise, the security objects O₁ and O₂ that they send must be consistent: the software element E₂ must be able to read the data transmitted by the software element E₁.

The communication channel C_{S} used for communication between the two security servers must be secure to prevent hacking at this level.

Regardless of the number of security servers, the security objects are transmitted over communication channels C₁ and C₂ which are secure, meaning that third party software elements are unable to understand the semantics of the data that they carry.

Secure communication channels can be set up using the prior art solutions previously described. For example, the data (in this case the code of the security objects) can be encrypted using an encryption key negotiated between the security server and each of the software elements and known only to them.

Also, it is of primary importance that the communication channels C₁ and C₂ are secure at least in terms of authentication and integrity. In other words, the software elements E₁ and E₂ must be certain of the source of the security objects O₁ and O₂, in other words that they really come from the security server S (this is the concept of authentication) and have not been modified while in transit on the communication channels (this is the concept of integrity).

It is necessary to guard against fake security servers sending malevolent security objects or malevolent modifications to the security objects (possibly accidental modifications).

For example, the channels C₁ and C₂ can be secured using the Transport Layer Security (TLS) protocol, which is described in RFC (Request For Comments) 2246 issued by the IETF (Internet Engineering Task Force). That protocol enables client/server applications to communicate by providing the authentication and integrity services required for the channels. To offer those services, TLS uses algorithms such as the triple-DES or IDEA algorithm and certificates conforming to Recommendation X.509 of the ITU-T (International Telecommunication Union, Telecommunication part).

The communication channels and the communication servers can be set up at system initialization time, i.e. before malevolent intrusion into the system. They are therefore free of the weaknesses previously described that the solution according to the invention proposes to overcome.

The security objects O₁ and O₂ can be identical for each of the two software elements E₁ and E₂ or different, and in particular specific to the role of the software elements.

For example, there can be a class of objects to be sent to software elements having a communication initiating role (E₁), a class of objects to be sent to software elements having an acceptor role (E₂), and possibly a class of objects to be sent to software elements having a two-fold role.

The various roles of a software element in relation to one or more calls are described in RFC (Request For Comments) 2078 of the IETF (Internet Engineering Task Force) entitled “Generic Security Service—Application Programming Interface”, for example.

Java uses a migration technique to send an object. The technique is referred to as “serialization” and entails encoding one or more objects in a bit stream transmitted over a communication channel. At the receiver, the object(s) can be reconstructed from the bit stream.

This mechanism can easily be used in the context of the present invention, with the object of sending the security objects from the security server(s) to the software elements.

When it has received the security object O₁, the software element E₁ can invoke a method contained in that security object in order to send data securely over the communication channel C to the software element E₂.

The interface of this method preferably completely conceals the underlying security mechanisms. For example, the method can take the form:

Send_data(msg)

In other words, this means that the software element developer needs to know only the data to be sent (parameter “msg”), and then to invoke the method (which here is named “Send_data”).

The implementation of this method (contained in the security object O₁) is responsible for implementing one or more security mechanisms available in the prior art (or new ones), in order to send the data “msg”. For example, it can communicate with an authentication server, encrypt the data, etc.

Similarly, the software element E₂ receives one or more security objects O₂ from the security server S.

In a first embodiment of the invention the class of the security object O₂ is not the same as that of the security object O₁. The class of the security object O₁ includes only one or more methods of sending data, whereas the class of the security object O₂ includes methods of receiving data.

In a second embodiment of the invention the classes of the security objects O₁ and O₂ are identical and include methods of sending and receiving data.

Once again, there are two options:

The first option is for the class of the security objects O₁ and O₂ to include at least two different methods, one for sending data (the method “Send-data” previously referred to) and the other for receiving data (for example named “Receive_data”).

The second option is for the class of the security objects to include only one method of sending and receiving data. This facilitates developing the software applications E₁ and E₂ because the developer needs to know only one method interface.

That interface takes the following form, for example:

Send (msg) in which the parameter “msg” represents the data to be sent or received.

In a first embodiment, the interface of the “Send” method includes a second parameter which indicates sending or receiving.

In a second embodiment that indication is implicit, in the class to which the parameter “msg” belongs. Typically, two classes can be used, one to send data represented by “msg” and the other to receive data and store it in accordance with the parameter “msg” (which can be a pointer to a memory area, for example).

What is more, the method(s) (“Send”, “Send_data”, “Receive_data”) are preferably terminal, i.e. they cannot be redefined by having the class of the security object that is sent inherit a new class. This would be a weakness in the security method.

Another result of making a method terminal is to make the object code generated by the compiler more concise. In that the object code is sent over a communication channel, this is an important advantage to be exploited.

In one embodiment of the invention the security objects are sent when communication is initialized and destroyed when communication is terminated.

This increases the security of the invention. Destroying the security objects on terminating the communication and sending them from the security server on initializing a new call reduces the time for which the security objects remain in the memory of the processor system on which the software element necessitating the security object is implemented.

Consequently, this reduces the time for which a hacker can attempt to access the code of the security object by reading the content of the memory. As previously mentioned, the security of the mechanism is weakened if the code of the security object and therefore the mechanism it uses are known. Hacking can then entail no more than searching for an encryption key, for example, which, although difficult if the encryption key is chosen judiciously, is nevertheless easier than searching for the security mechanism itself.

There is claimed:

1. A method of securing communication between a first software element and a second software element via a non-secure communication channel in collaboration with a security server, in which method data carried by said communication channel is sent using a method of a security object supplied by said security server.

2. The method claimed in claim 1 wherein said security object is sent by said security server over a secure channel.

3. The method claimed in claim 1 wherein said security object is sent on initialization of said communication and destroyed on termination of said communication.

4. The method claimed in claim 1 wherein said security object includes a method of sending and receiving data over said non-secure communication channel.

5. A software element adapted to set up secure communication with another software element over a non-secure communication channel in collaboration with a security server, which software element includes:
a communication module for sending data via said communication channel in secured manner, and
means for receiving a new communication module from said security server.
